(19) United States
(12) Patent Application Publication
(10) Pub. No.: US 2022/0157334 A1
(43) Pub. Date: May 19, 2022

(54) DETECTION OF LIVE SPEECH

(71) Applicant: Cirrus Logic International Semiconductor Ltd., Edinburgh (GB)

(72) Inventor: César ALONSO, Madrid (ES)

(73) Assignee: Cirrus Logic International Semiconductor Ltd., Edinburgh (GB)

(21) Appl. No.: 16/953,104

(22) Filed: Nov. 19, 2020

(51) Int. Cl. G10L 25/93; G10L 25/18; G10L 25/21; G10L 15/22; G10L 25/78

(52) U.S. Cl. CPC G10L 25/93; G10L 25/18; G10L 2025/937; G10L 15/22; G10L 25/78; G10L 25/21

(57) ABSTRACT

A method of detecting live speech comprises: receiving a signal containing speech; forming a framed version of the received signal that comprises a plurality of frames; forming a first subset of the plurality of frames, wherein each frame of the first subset contains a signal that contains voiced speech; forming a second subset of the plurality of frames, wherein each frame of the second subset contains a signal that contains unvoiced speech; forming a first frame that is representative of a sum of a plurality of frames of the first subset; forming a second frame that is representative of a sum of a plurality of frames of the second subset; performing a time-frequency transformation operation on the first frame, to form an average voiced frequency spectrum; performing a time-frequency transformation operation on the second frame, to form an average unvoiced frequency spectrum; obtaining one or more voiced features from the voiced frequency spectrum; and obtaining one or more unvoiced features from the unvoiced frequency spectrum. Based on the one or more voiced features and the one or more unvoiced features, a determination is made whether the speech is live speech, or not.

### TECHNICAL FIELD

Embodiments described herein relate to methods and devices for detecting live speech.

As one example, the detection of live speech can be used for detecting a replay attack on a voice biometrics system.

### BACKGROUND

Speech recognition systems are known, allowing a user to control a device or system using spoken commands. It is common to use speaker recognition systems in conjunction with speech recognition systems. A speaker recognition system can be used to verify the identity of a person who is speaking, and this can be used to control the operation of the speech recognition system.

As an illustration of this, a spoken command may relate to the personal tastes of the speaker. For example, the spoken command may be “Play my favourite music”, in which case it is necessary to know the identity of the speaker before it is possible to determine which music should be played.

As another illustration, a spoken command may relate to a financial transaction. For example, the spoken command may be an instruction that involves transferring money to a specific recipient. In that case, before acting on the spoken command, it is necessary to have a high degree of confidence that the command was spoken by the presumed speaker.

One issue with systems that use speech recognition is that they can be activated by speech that was not intended as a command. For example, speech from a TV in a room might be detected by a smart speaker device, and might cause the smart speaker device to act on that speech, even though the owner of the device did not intend that.

Speaker recognition systems often use a voice biometric, where the received speech is compared with a model generated when a person enrols with the system. This attempts to ensure that a device only acts on a spoken command if it was in fact spoken by the enrolled user of the device.

One issue with this system is that it can be attacked by using a recording of the speech of the enrolled speaker, in a replay attack.

### SUMMARY

According to a first aspect of the invention, there is provided a method of detecting live speech, the method comprising, receiving a signal containing speech, forming a framed version of the received signal that comprises a plurality of frames, forming a first subset of the plurality of frames, wherein each frame of the first subset contains a signal that contains voiced speech, forming a second subset of the plurality of frames, wherein each frame of the second subset contains a signal that contains unvoiced speech, forming a first frame that is representative of a sum of a plurality of frames of the first subset, forming a second frame that is representative of a sum of a plurality of frames of the second subset, performing a time-frequency transformation operation on the first frame, to form an average voiced frequency spectrum, performing a time-frequency transformation operation on the second frame, to form an average unvoiced frequency spectrum, obtaining one or more voiced features from the average voiced frequency spectrum, obtaining one or more unvoiced features from the average unvoiced frequency spectrum, and determining whether the speech is live speech, wherein the determination is based on the one or more voiced features and the one or more unvoiced features.

The time-frequency transformation operation may comprise at least in part a discrete Fourier transform.

The method may further comprise applying a weight to the average voiced frequency spectrum to form a weighted average voiced frequency spectrum; and obtaining said one or more voiced features from the weighted average voiced frequency spectrum.

The weight may be based on the energy of the first frame or the second frame.

The method may further comprise applying a weight to energy of the average unvoiced frequency spectrum to form a weighted average unvoiced frequency spectrum, and obtaining said one or more unvoiced features from the weighted average unvoiced frequency spectrum.

The weight may be based on the energy of the first frame or the second frame.

The step of forming a framed version of the received signal may comprise varying an overlap between two or more frames of the plurality of frames.

The overlap may be varied randomly.

The steps of forming a first subset of the plurality of frames, and forming a second subset of the plurality of frames, may comprises, for each frame of the plurality of frames determining whether the signal comprised within the frame contains voiced speech or unvoiced speech according to a method of according to a fourth aspect of the invention.

The method may further comprise, responsive to it being determined that the speech is live speech, executing a voice biometrics process.

Each frequency spectrum may comprise a respective power spectral density.

According to a second aspect of the invention, there is provided a system for detecting live speech, the system comprising an input for receiving an audio signal, and being configured for: receiving a signal containing speech; forming a framed version of the received signal that comprises a plurality of frames; forming a first subset of the plurality of frames, wherein each frame of the first subset contains a signal that contains voiced speech; forming a second subset of the plurality of frames, wherein each frame of the second subset contains a signal that contains unvoiced speech; forming a first frame that is representative of a sum of a plurality of frames of the first subset; forming a second frame that is representative of a sum of a plurality of frames of the second subset; performing a time-frequency transformation operation on the first frame, to form an average voiced frequency spectrum; performing a time-frequency transformation operation on the second frame, to form an average unvoiced frequency spectrum; obtaining one or more voiced features from the average voiced frequency spectrum; obtaining one or more unvoiced features from the average unvoiced frequency spectrum; and determining whether the speech is live speech, wherein the determination is based on the one or more voiced features and the one or more unvoiced features.

According to a third aspect of the invention, there is provided a non-transitory computer readable storage medium having computer-executable instructions stored thereon that, when executed by processor circuitry, cause the processor circuitry to perform a method according to the first aspect.

According to a fourth aspect of the invention, there is provided a method of determining whether a signal contains voiced speech or unvoiced speech, the method comprising: performing a first high pass filtering process on the signal to form a filtered signal; performing a second high pass filtering process on the filtered signal to form a second filtered signal; performing a low pass filtering process on the filtered signal to form a third filtered signal; calculating the energy of the second filtered signal; calculating the energy of the third filtered signal; comparing the energy of the second filtered signal and the energy of the third filtered signal; and based on said comparison, determining whether the signal contains voiced speech, or contains unvoiced speech.

The method may further comprise, prior to performing a first high pass filtering process: downsampling the signal contained to form a downsampled signal.

The first high pass filtering process may comprise a cutoff frequency between 50-150 Hz.

The second high pass filtering process may comprise a cutoff frequency between 3000-8000 Hz.

The low pass filtering process may comprise a cutoff frequency between 700-3000 Hz.

The step of determining whether the signal contains voiced speech, or contains unvoiced speech may comprise responsive to the energy of the second filtered signal exceeding the energy of the third filtered signal, determining that the signal contains voiced speech; and responsive to the energy of the second filtered signal failing to exceed the energy of the third filtered signal, determining that the signal that contains unvoiced speech.

The one or more of the first high pass filtering process, the second high pass filtering process and the low pass filtering process may comprise a Chebyshev filtering process.

According to a fifth aspect of the invention, there is provided a system for determining whether a signal contains voiced speech or unvoiced speech, the system comprising an input for receiving an audio signal, and being configured for performing a first high pass filtering process on the signal to form a filtered signal; performing a second high pass filtering process on the filtered signal to form a second filtered signal; performing a low pass filtering process on the filtered signal to form a third filtered signal; calculating the energy of the second filtered signal; calculating the energy of the third filtered signal; comparing the energy of the second filtered signal and the energy of the third filtered signal; and based on said comparison, determining whether the signal contains voiced speech, or contains unvoiced speech.

According to a sixth aspect of the invention, there is provided a non-transitory computer readable storage medium having computer-executable instructions stored thereon that, when executed by processor circuitry, cause the processor circuitry to perform a method according to the fourth aspect.

According to a seventh aspect of the invention, there is provided a method of detecting live speech, the method comprising: receiving a signal containing speech; forming a framed version of the received signal that comprises a plurality of frames; forming a first subset of the plurality of frames, wherein each frame of the first subset contains a signal that contains voiced speech; forming a first frame that is representative of a sum of a plurality of frames of the first subset; performing a time-frequency transformation operation on the first frame, to form an average voiced frequency spectrum; obtaining one or more voiced features from the average voiced frequency spectrum; determining whether the speech is live speech, wherein the determination is based on the one or more voiced features.

The steps of forming a first subset of the plurality of frames may comprise: performing a voice activity detection process on the signal contained in the frame; and responsive to voice activity being detected in the signal contained in the frame, determining that the frame contains a signal that contains voiced speech.

The time-frequency transformation operation may comprise a discrete Fourier transform.

The method may further comprises applying a weight to the average voiced frequency spectrum to form a weighted average voiced frequency spectrum; and obtaining said one or more voiced features from the weighted average voiced frequency spectrum.

The weight may be based on the energy of the first frame.

The step of forming a framed version of the received signal may comprise varying an overlap between two or more frames of the plurality of frames.

The overlap may be varied randomly.

The method may further comprises, responsive to it being determined that the speech is live speech, executing a voice biometrics process.

Each frequency spectrum may comprise a respective power spectral density.

According to an eighth aspect of the invention, there is provided a system for detecting live speech, the system comprising an input for receiving an audio signal, and being configured for: receiving a signal containing speech; forming a framed version of the received signal that comprises a plurality of frames; forming a first subset of the plurality of frames, wherein each frame of the first subset contains a signal that contains voiced speech; forming a first frame that is representative of a sum of a plurality of frames of the first subset; performing a time-frequency transformation operation on the first frame, to form an average voiced frequency spectrum; obtaining one or more voiced features from the average voiced frequency spectrum; determining whether the speech is live speech, wherein the determination is based on the one or more voiced features.

According to an ninth aspect of the invention, there is provided a non-transitory computer readable storage medium having computer-executable instructions stored thereon that, when executed by processor circuitry, cause the processor circuitry to perform a method according to the seventh aspect.

### BRIEF DESCRIPTION OF DRAWINGS

For a better understanding of the present invention, and to show how it may be put into effect, reference will now be made to the accompanying drawings, in which:

FIG. 1 illustrates a smartphone;

FIG. 2 is a schematic diagram, illustrating the form of the smartphone;

FIG. 3 illustrates a situation in which a replay attack is being performed;

FIG. 4 is a block diagram illustrating a speaker recognition system;

FIG. 5 is a flow chart illustrating a method of detecting live speech;

FIG. 6 is a block diagram illustrating a system for detecting live speech;

FIG. 7 shows examples of the power density spectra generated by a time-frequency transformation block;

FIG. 8 is flow chart illustrating a method of determining whether a signal contains voiced speech or unvoiced speech;

FIG. 9 is a block diagram illustrating a system for determining whether a signal contains voiced speech or unvoiced speech;

FIG. 10(a) shows examples of filtered signals produced by the different filtering blocks.

FIG. 10(b) shows examples of speech frames which have been marked by a comparison block as voiced frames, or as unvoiced frames;

FIG. 11 is a flow chart illustrating a further method of detecting live speech; and

FIG. 12 is a block diagram illustrating a further system for detecting live speech.

### DETAILED DESCRIPTION OF EMBODIMENTS

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The methods described herein can be implemented in a wide range of devices and systems, for example a mobile telephone, an audio player, a video player, a mobile computing platform, a games device, a remote controller device, a toy, a machine, or a home automation controller or a domestic appliance. However, for ease of explanation of one embodiment, an illustrative example will be described, in which the implementation occurs in a smartphone.

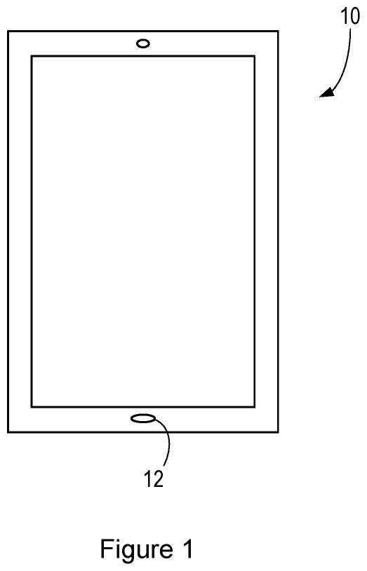

FIG. 1 illustrates a smartphone 10, having a microphone 12 for detecting ambient sounds. In normal use, the microphone is of course used for detecting the speech of a user who is holding the smartphone 10 close to their face.

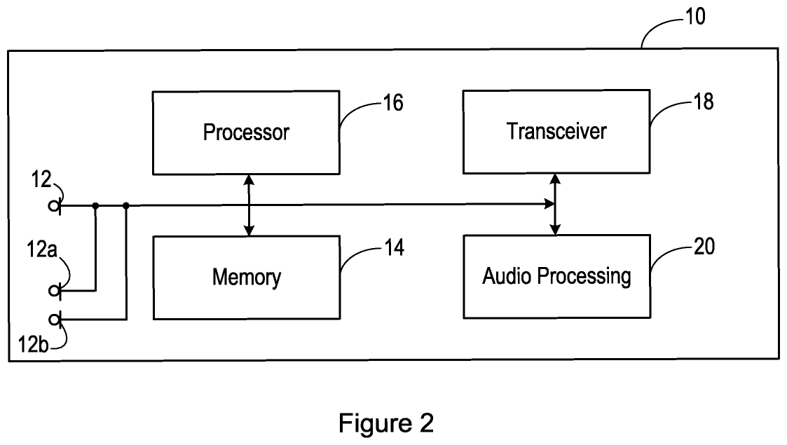

FIG. 2 is a schematic diagram, illustrating the form of the smartphone 10.

Specifically, FIG. 2 shows various interconnected components of the smartphone 10. It will be appreciated that the smartphone 10 will in practice contain many other components, but the following description is sufficient for an understanding of the present invention.

Thus, FIG. 2 shows the microphone 12 mentioned above. In certain embodiments, the smartphone 10 is provided with multiple microphones 12, 12a, 12b, etc.

FIG. 2 also shows a memory 14, which may in practice be provided as a single component or as multiple components. The memory 14 is provided for storing data and program instructions.

FIG. 2 also shows a processor 16, which again may in practice be provided as a single component or as multiple components. For example, one component of the processor 16 may be an applications processor of the smartphone 10.

FIG. 2 also shows a transceiver 18, which is provided for allowing the smartphone 10 to communicate with external networks. For example, the transceiver 18 may include circuitry for establishing an internet connection either over a WiFi local area network or over a cellular network.

FIG. 2 also shows audio processing circuitry 20, for performing operations on the audio signals detected by the microphone 12 as required. For example, the audio processing circuitry 20 may filter the audio signals or perform other signal processing operations.

In this embodiment, the smartphone 10 is provided with voice biometric functionality, and with control functionality. Thus, the smartphone 10 is able to perform various functions in response to spoken commands from an enrolled user. The biometric functionality is able to distinguish between spoken commands from the enrolled user, and the same commands when spoken by a different person. Thus, certain embodiments of the invention relate to operation of a smartphone or another portable electronic device with some sort of voice operability, for example a tablet or laptop computer, a games console, a home control system, a home entertainment system, an in-vehicle entertainment system, a domestic appliance, or the like, in which the voice biometric functionality is performed in the device that is intended to carry out the spoken command. Certain other embodiments relate to systems in which the voice biometric functionality is performed on a smartphone or other device, which then transmits the commands to a separate device if the voice biometric functionality is able to confirm that the speaker was the enrolled user.

In some embodiments, while voice biometric functionality is performed on the smartphone 10 or other device that is located close to the user, the spoken commands are transmitted using the transceiver 18 to a remote speech recognition system, which determines the meaning of the spoken commands. For example, the speech recognition system may be located on one or more remote server in a cloud computing environment. Signals based on the meaning of the spoken commands are then returned to the smartphone 10 or other local device. In other embodiments, the speech recognition system is also located on the device 10.

One attempt to deceive a voice biometric system is to play a recording of an enrolled user's voice in a so-called replay or spoof attack.

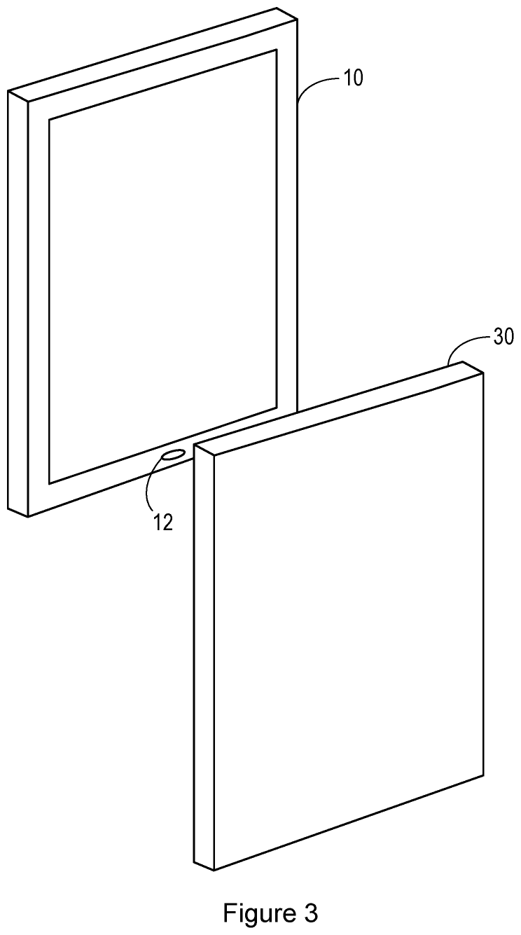

FIG. 3 shows an example of a situation in which a replay attack is being performed. Thus, in FIG. 3, the smartphone 10 is provided with voice biometric functionality. In this example, the smartphone 10 is in the possession, at least temporarily, of an attacker, who has another smartphone 30. The smartphone 30 has been used to record the voice of the enrolled user of the smartphone 10. The smartphone 30 is brought close to the microphone inlet 12 of the smartphone 10, and the recording of the enrolled user's voice is played back. If the voice biometric system is unable to detect that the enrolled user's voice that it detects is a recording, the attacker will gain access to one or more services that are intended to be accessible only by the enrolled user.

In an effort to address this, the smartphone 10 may be further configured to determine whether a received signal contains live speech, prior to the execution of a voice biometrics process on the received signal. For example, the smartphone 10 may be configured to confirm that any voice sounds that are detected are live speech, rather than being played back, in an effort to prevent a malicious third party executing a replay attack from gaining access to one or more services that are intended to be accessible only by the enrolled user. In other examples, the smartphone 10 may be further configured to execute a voice biometrics process on a received signal. If the result of the voice biometrics process is negative, e.g. a biometric match is not found, a determination of whether the receive signal contains live speech may not be required.

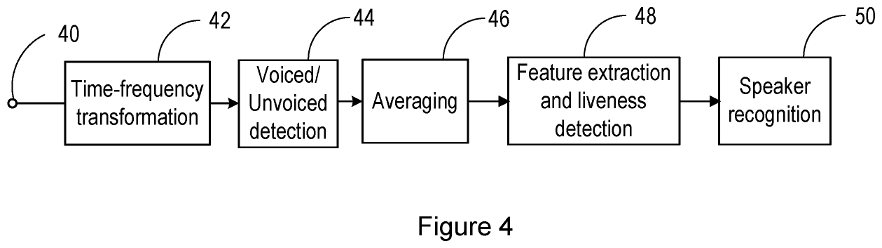

FIG. 4 is a block diagram illustrating a speaker recognition system that is also configured to determine whether a received signal contains live speech.

Firstly, an audio signal is received on an input 40 of the system shown in FIG. 4. The input 40 may comprise the microphone 12, as described above.

The received signal then is divided into frames, which may for example have lengths in the range of 10-100 ms. In some embodiments, the frames may feature a degree of overlap with one another.

The frames of the received signal are then passed to a time-frequency transformation block 42. For each frame of the received signal, the time-frequency transformation block 42 performs a time-frequency transformation operation to form a power spectral density. In some embodiments, the time-frequency transformation operation may comprise at least in part a discrete Fourier transform. However, it will be appreciated that the time-frequency transformation operation may comprise any suitable transformation or transformations that allow a power spectral density to be formed.

The transformed frames are then passed to a voiced/unvoiced detection block 44. The voiced/unvoiced detection block 44 then identifies which of the received frames contain voiced speech, and which contain unvoiced speech. Voiced and unvoiced speech may be defined as follows. Speech is composed of phonemes, which are produced by the vocal cords and the vocal tract (which includes the mouth and the lips). Voiced signals are produced when the vocal cords vibrate during the pronunciation of a phoneme. Unvoiced signals, by contrast, do not entail the use of the vocal cords. For example, the only difference between the phonemes /s/ and /z/ or /f/ and /v/ is the vibration of the vocal cords. Voiced signals tend to be louder like the vowels /a/, /e/, /i/, /u/, /o/. Unvoiced signals, on the other hand, tend to be more abrupt like the stop consonants /p/, /t/, /k/.

The skilled person will be aware of a number of suitable methods that may be implemented by the voiced/unvoiced detection block 44 in order to identify frames containing voiced speech, and frames containing unvoiced speech. For example, the voiced/unvoiced detection block 44 may, for each received frame, determine spectral centroids based on the signal contained within that frame, and then use the determined spectral centroids to determine whether the frame contains voiced speech, or contains unvoiced speech.

The voiced frames and the unvoiced frames are then passed to an averaging block 46. The averaging block 46 forms an average voiced frame that is representative of the sum of the received voiced frames, and an average unvoiced frame that is representative of the sum of the received unvoiced frames.

The average voiced frame, and the average unvoiced frame, are then passed to a liveness detection block 48. The liveness detection block 48 is configured to determine whether the received average voiced and unvoiced frames contain live speech, or not. For example, this determination may be based on the frequency properties of the voiced speech, and/or the frequency properties of the unvoiced speech. For example, the liveness detection block 48 may test whether a particular spectral ratio for the voiced speech and/or the unvoiced speech (for example a ratio of the signal energy from 0-2 kHz to the signal energy from 2-4 kHz) has a value that may be indicative of replay through a loudspeaker. Additionally or alternatively, the liveness detection block 48 may test whether the ratio of the energy within a certain frequency band to the energy of the complete power spectral density has a value that may be indicative of replay through a loudspeaker, for both the voiced speech and the unvoiced speech. Additionally or alternatively, the determination may be based on spectral coefficients that have been calculated for both the voiced frame, and the unvoiced frame, and whether these spectral coefficients are indicative of playback through a loudspeaker. Additionally or alternatively, properties about a channel and/or noise may be obtained from the voiced speech and/or the unvoiced speech, and the determination may be based on whether the properties of the channel and/or noise are indicative of playback through a loudspeaker. The liveness detection block may only then pass the average voiced frame, and the average unvoiced frame, to a speaker recognition block 50, in response to the determination that the received speech signal does contain live speech. Alternatively, in response to the liveness detection block 48 determining that the received speech signal does not contain live speech (as would be the case in a replay attack), the liveness detection block 48 may prevent the speaker recognition block 50 from being activated, thus ending the process.

In some embodiments, where the provider of the received audio signal has not provided a claimed identity to the smartphone 10, the speaker recognition block 50 may identify the speaker of the received audio signal based on the received frames that contain voiced speech, and/or the received frames that contain unvoiced speech. In other embodiments, where the provider of the received audio signal has provided a claimed identity to the smartphone 10, the speaker recognition block may instead verify the speaker of the received audio signal based on the received frames that contain voiced speech, and/or the received frames that contain unvoiced speech. The skilled person will be familiar with a number of suitable methods of both speaker verification and speaker identification that may be executed by the speaker recognition block 50.

It will be appreciated that, in the system of FIG. 4, the step of performing a time-frequency transformation operation on each frame of the received signal can be both a computationally expensive and time consuming process. In the known Welch method, an estimate of the power spectral density of a digital signal may be calculated by dividing the signal into overlapping frames, computing a windowed DFT (or periodogram) for each frame, and then averaging these frequency-transformed frames. It will be appreciated that if a signal is divided into F frames, wherein each frame then contains N samples, and where the DFT has also length N, that the computational cost of this method will be approximately F*Nlog2(N).

Considering the discrete Fourier transform as one suitable time-frequency transformation, the discrete Fourier transform transforms a sequence of N complex numbers, {xₙ}, in the time domain into another sequence of complex numbers, {xₖ}, in the frequency domain, defined by the following equation (1):

$${X}_{k} = {\sum }_{n = 0}^{N - 1} {x}_{n} ( cos \frac{2 π kn}{N} - i sin \frac{2 π kn}{N} ) \qquad ( 1 )$$

Similarly, for a second sequence of N complex numbers, {yₙ}, the discrete Fourier transform is defined by equation (2) is as follows:

$${Y}_{k} = {\sum }_{n = 0}^{N - 1} {y}_{n} ( cos \frac{2 π kn}{N} - i sin \frac{2 π kn}{N} ) \qquad ( 2 )$$

A discrete Fourier transform can be performed on a signal. The power spectral density for that signal can then be calculated by taking the square of absolute value of the result of the discrete Fourier transform.

When considering forming an average of a number of signals, or equivalently, a number of frames of a signal (and hence, summing those signals together to form said average), it is apparent that the sum of the squares of the results of the discrete Fourier transform for the frames of a signal (in other words, where the average frame is formed following the frequency transformation) is different to the square of the sum of the results of the discrete Fourier transform for the frames (in other words, where the average frame is formed prior to the frequency transformation). These differences are also apparent when considering equations (3) and (4) below, which for simplicity consider only two frames:

|Xₖ+Yₖ|²=Re{Xₖ+Yₖ}²+Im{Xₖ+Yₖ}² (3)

|Xₖ|²+|Yₖ|²=Re{Xₖ}²+Im{Xₖ}²+Re{Yₖ}²+Im{Yₖ}² (4)

In the first example, where the result of the discrete Fourier transform for each frame is squared prior to the final summation, each of these results become positive contributors to the final sum. However, where the result of the discrete Fourier transform for each frame is summed prior to the squaring of the final result, the results may have opposite signs, and thus a degree of cancellation may occur prior to the squaring of this result.

It has been found that, where the frame size is large enough to contain several periods of the lowest frequency component of the signal, and where the hop-size (or frame overlap) for the framing is approximately half of the frame size, the randomly-cut segments of signal that are comprised within the different frames will be, in general, incoherent. Therefore, the vectors formed from these frames will be approximately orthogonal, and therefore, the scalar product of these vectors will be approximately zero.

Using again the example of two consecutive frames x and y we can express previous statement as (5):

Σₙ₌₀^{N-1}|xₙ+yₙ|²=Σₙ₌₀^{N-1}[|xₙ|²+|yₙ|²+2 xₙ·yₙ]≈Σₙ₌₀^{N-1}[|xₙ|²+|yₙ|²] (5)

where N is the length of the analysis window (the frame size) and the length of the FFT, and xₙ and yₙ are two consecutive segments of a time domain signal that are approximately orthogonal.

Considering also Parseval's relation:

$${\sum }_{n = 0}^{N - 1} {\vert {x}_{n} \vert}^{2} = \frac{1}{N} {\sum }_{k = 0}^{N - 1} {\vert {X}_{k} \vert}^{2} \qquad ( 6 )$$

we can conclude that for frames meeting the orthogonality condition as in (5), approximation (7) is also valid:

$${\sum }_{n = 0}^{N - 1} {\vert {x}_{n} + {y}_{n} \vert}^{2} \approx \frac{1}{N} {\sum }_{k = 0}^{N - 1} [ {\vert {X}_{k} \vert}^{2} + {\vert {Y}_{k} \vert}^{2} ] \qquad ( 7 )$$

That is, the energy of the sum of the module of the FFT of the frames (or, similarly, the average energy) can be accurately estimated using the energy of the sum of the frames in the time domain. Note that this relationship (7) generalizes to an arbitrary number of frames, as long as they are approximately orthogonal:

$${\sum }_{n = 0}^{N - 1} {\sum }_{f = 0}^{F - 1} {\vert {x}_{fn} \vert}^{2} \approx \frac{1}{N} ( {\sum }_{k = 0}^{N - 1} {\sum }_{f = 0}^{F - 1} {\vert {X}_{fk} \vert}^{2} ) \qquad ( 8 )$$

where f in xᵢₙ and X_{fk} represents the frame number, and F is the total number of frames into which the signal is divided.

If the approximation (8) is valid for a given decomposition in frames of a single sinusoid, the linearity of the DFT ensures that (8) is equally valid for a sum of sinusoids, which is to say, by Fourier's theorem, that the approximation is valid for virtually any signal that can be decomposed in frames that meet condition (5).

It has been found that for a wide range of signals including white noise, red noise, and signals with a mixture of tonal and noisy components, such as voice signals, both the total energy, and the energy of each frequency component, can be approximated using the above method.

It has also been found that, if the frame size is large in comparison to the wavelength of the lowest significant frequency component of the signal, and the power frequency spectrum is further smoothed (e.g. using a median or an averaging filter) on the frequency bins of the PSD, the total energy and the energy of each frequency component, can be approximated more accurately. Furthermore, it has been found that for the aforementioned signals, the average angle between the vectors formed from consecutive frames is approximately 90°. That is, they are, on average, approximately orthogonal.

Therefore, the power density spectrum obtained by averaging a number of frames of a signal in the time domain, and then performing a time-frequency transformation operation on the averaged frame (referred to herein as the first method), is similar to the power density spectrum obtained by averaging the power density spectrums obtained by performing time-frequency transformation operations on each of the number of frames of the signal in the time domain (as is performed in the known Welch method). However, it will be appreciated that, as only one time-frequency transformation operation needs to be performed (on one average frame) in the first method, the first method is considerably less computationally intensive, and considerably faster, than the known Welch method.

10

As noted previously, the first method requires that the signal under analysis is divided into approximately orthogonal (or incoherent) frames. We shall now consider which signals are known to not be possibly divided into such frames. Considering a framing decomposition with analysis window of size Wand hop-size H=W/2, if the signal under analysis sampled at a rate Fs that has a periodic component at a frequency Fc meets the following condition:

H*Fc/Fs=integer number (9)

all frames of such signal will contain exactly the same portion of the sinusoid with frequency Fc (the periodic component). The averaging of frames in time domain will be perfectly coherent for this component at frequency Fc -or other components meeting condition (9)-even if the other frequency components are added incoherently. This can translate into an abnormal prominence of this component at Fc (and its sidelobes due to the windowing effect) in the PSD.

This situation may be avoided or ameliorated by varying the hop-size for framing (rather than defining a fixed hop-size for the framing). For example, the hop-size may be randomized. In doing so, that the condition (9) above will not be met for any tone with a stable frequency. In some embodiments, this may be implemented by making the hop-size a plurality of samples bigger or a plurality of samples smaller for each new frame (for example, +1 or −1 sample which may be chosen randomly and/or with uniform probability) such that the number of frames in which the signal will be ultimately divided will be substantially, if not exactly, the same as if the hop-size was fixed.

By implementing the above regime, the likelihood of the frames of a signal being added coherently is significantly diminished, since this would require the phase of the signal to be perfectly synchronized to the random selection of the hop-size, which is highly unlikely.

Again, linearity of the DFT and Fourier's theorem ensure that if all sinusoidal components of a signal, including the subset of sinusoids that meet condition (9), can be segmented in approximately orthogonal frames, the PSD estimation obtained by execution of the first method described above may be approximately equivalent to the PSD obtained by the Welch method. It will be appreciate that choice of parameters (window size, DFT size, dynamic hop-size) taking into account the frequency content of the signal under analysis may improve the accuracy of the estimation by ensuring as much as possible the orthogonality of the frames into which the signal is segmented. It has also been found that, as noted above, a suitable PSD smoothing (for example, using average or median filters) that does not conceal the frequency characteristics of interest can also improve the accuracy of the estimation.

Systems and methods implementing this first method are described below.

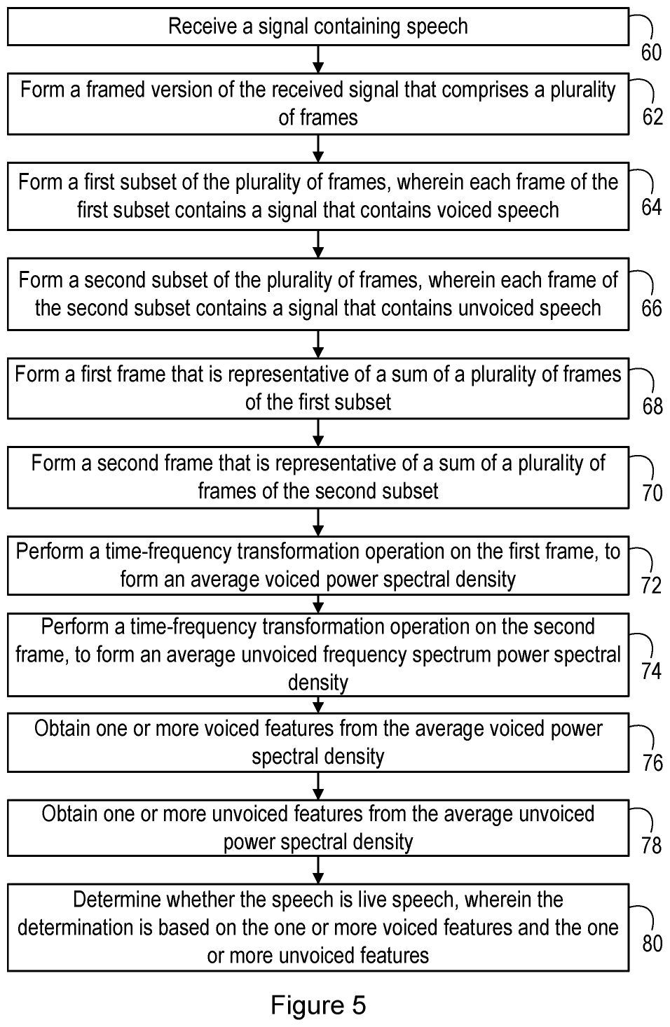

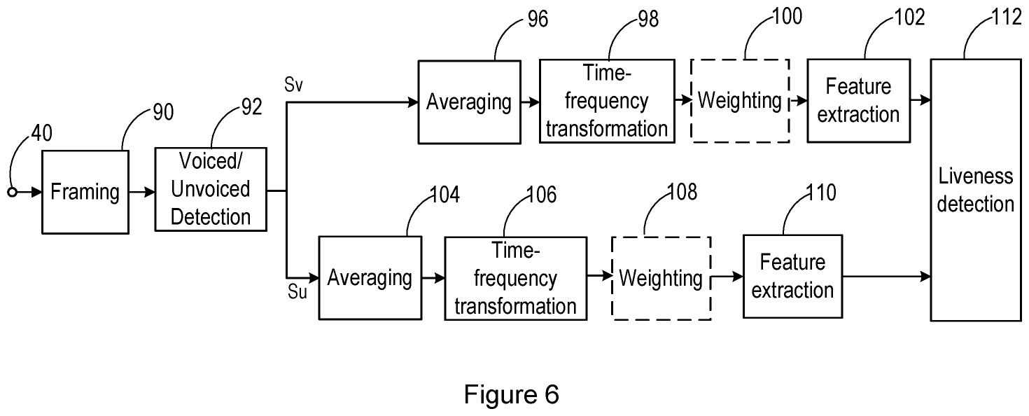

FIG. 5 is a flow chart illustrating a method of detecting live speech, and FIG. 6 is a block diagram illustrating a system for detecting live speech.

Specifically, in step 60 of the method FIG. 5, a signal containing speech is received on an input 40 of the system shown in FIG. 6. As mentioned above, the input 40 may comprise the microphone 12 as described above.

The received signal then is divided into frames, which may for example have lengths in the range of 10-100 ms. In some embodiments, the frames may feature a degree of overlap with one another. Thus, as shown in step 62 of FIG. 5, a framed version of the received signal that comprises a plurality of frames is formed. The framed version of the received signal is then passed to a voiced/unvoiced detection block 92. It will be appreciated that, in some embodiments, the framed version of the received signal may be formed such that the overlap between the frames is not constant. For example, two successive overlaps may vary by a predetermined number of samples (for example, between 1-3 samples).

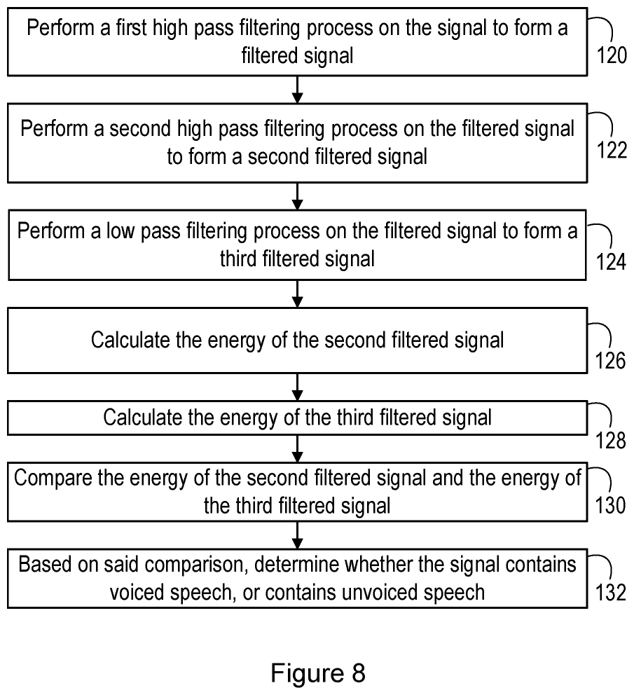

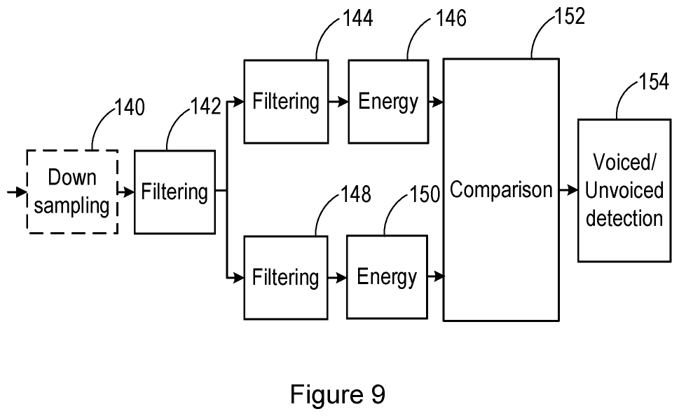

The voiced/unvoiced detection block 92 forms a first subset of the plurality of frames, wherein each frame of the first subset contains a signal that contains voiced speech, Sv, as shown in step 64 of FIG. 5. The voiced/unvoiced detection block 92 also forms a second subset of the plurality of frames, wherein each frame of the second subset contains a signal that contains unvoiced speech, Su, as shown in step 66 of FIG. 5. The steps of forming a first subset of the plurality of frames, and forming a second subset of the plurality of frames, by the voiced/unvoiced detection block 92 may comprise, for each of the plurality frames, determining whether the signal contained within the frame contains voiced speech or unvoiced speech. It will be appreciated that, in this example, the frames that are received at the voiced/unvoiced detection block 92 are in the time domain. Thus, in this illustrated example, the voiced/unvoiced detection block 92 may implement any suitable method for determining whether a received signal contains voiced or unvoiced speech in the time domain. One example of such a method is described below in relation to FIGS. 8 and 9.

The plurality of frames of the first subset may then be passed to an averaging block 96. The averaging block 96 forms a first frame that is representative of a sum of a plurality of frames of the first subset, as shown in step 68 of FIG. 5. For example, the first frame may comprise an average frame that is based on a sum of the plurality of frames of the first subset. In some embodiments, the process of forming a sum of the plurality of frames may be an analog computing process.

The first frame is then passed to a time-frequency transformation block 98. The time-frequency transformation block 98 performs a time-frequency transformation operation on the first frame to form an average voiced power spectral density, as shown in step 72 of FIG. 5. In some embodiments, the time-frequency transformation operation may comprise at least in part a discrete Fourier transform. However, it will be appreciated that the time-frequency transformation operation may comprise any suitable transformation or transformations that allow a power spectral density to be formed.

The average voiced power spectral density may then optionally be passed to a weighting block 100. The weighting block 100 may apply a weight to the average voiced power spectral density to form a weighted average voiced power spectral density. In some embodiments, the weight may be based on the energy of the first frame or the second frame. It will be appreciated that the weighting process may compensate for energy that may have been lost when the average voiced power spectral density was initially formed.

The average voiced power spectral density may then be passed to a feature extraction block 102. The feature extraction block 102 obtains one or more voiced features from the average voiced power spectral density, as shown in step 76 of FIG. 5. It will be appreciated that, where a weighted average voiced power spectral density has been received from the weighting block 102, the one or more voiced features may be obtained from the weighted average voiced power spectral density. It will be appreciated that the feature extraction block 102 may obtain any voiced features from the average voiced power spectral density that are suitable for use in a liveness detection process. For example, a ratio of the signal energy from 20-40 kHz (ultrasonic) to the signal energy from 100 Hz-20 kHz (audible) may be obtained. Additionally or alternatively, a ratio of the energy within a certain frequency band to the energy of the complete power spectral density may be obtained. Additionally or alternatively, spectral coefficients may be obtained. Additionally or alternatively, properties about a channel and/or noise may be obtained.

Referring now to the second subset of the plurality of frames, Su, the plurality of frames of the second subset are passed to an averaging block 104. The averaging block 104 forms a second frame that is representative of a sum of a plurality of frames of the second subset, as shown in step 70 of FIG. 5. For example, the second frame may comprise an average frame that is based on a sum of the plurality of frames of the second subset. In some embodiments, the process of forming a sum of a plurality of frames may be an analog computing process.

The second frame is then passed to a time-frequency transformation block 106. The time-frequency transformation block 106 performs a time-frequency transformation operation on the second frame to form an average unvoiced power spectral density, as shown in step 74 of FIG. 5. In some embodiments, the time-frequency transformation operation may comprise at least in part a discrete Fourier transform. However, it will be appreciated that the time-frequency transformation operation may comprise any suitable transformation or transformations that will allow a power spectral density to be formed.

The second frame may then optionally be passed to a weighting block 108. The weighting block 108 may apply a weight to the average unvoiced power spectral density to form a weighted average unvoiced power spectral density. In some embodiments, the weight may be based on the energy of the first frame or the second frame. This weighting may compensate for energy that may have been lost when the unvoiced power spectral density was formed.

The average unvoiced power spectral density may then be passed to a feature extraction block 110. The feature extraction block 110 may obtain one or more unvoiced features from the average unvoiced power spectral density, as shown in step 78 of FIG. 5. It will be appreciated that, where a weighted average unvoiced power spectral density has been received from the weighting block 90, the one or more unvoiced features may be obtained from the weighted average unvoiced power spectral density. It will be appreciated that the feature extraction block 102 may obtain any unvoiced features from the average unvoiced power spectral density that are suitable for use in a liveness detection process. For example, a ratio of the signal energy from 20-40 kHz (ultrasonic) to the signal energy from 100 Hz-15 kHz (audible) may be obtained. Additionally or alternatively, a ratio of the energy within a certain frequency band to the energy of the complete power spectral density may be obtained. Additionally or alternatively, spectral coefficients may be obtained. Additionally or alternatively, properties about a channel and/or noise may be obtained.

A liveness detection block 112 then receives the one or more voiced features from the feature extraction block 102, and the one or more unvoiced features from the feature extraction block 110. The liveness detection block 112 then determines whether the speech is live speech based on the one or more voiced features and the one or more unvoiced features, as shown in step 80 of FIG. 5. In some embodiments, this determination may be based on received frequency properties of the voiced speech, and the frequency properties of the unvoiced speech. Additionally or alternatively, the liveness detection block 112 may test whether a particular spectral ratio (for example a ratio of the signal energy from 20-40 kHz (ultrasonic) to the signal energy from 100 Hz-15 kHz (audible)) has a value that may be indicative of replay through a loudspeaker, for both the voiced speech and the unvoiced speech. Additionally or alternatively, the liveness detection block 112 may test whether the ratio of the energy within a certain frequency band to the energy of the complete power spectral density has a value that may be indicative of replay through a loudspeaker, for both the voiced speech and the unvoiced speech. Additionally or alternatively, the determination may be based on spectral coefficients that have been calculated for both the voiced power density spectrum, and the unvoiced power density spectrum, and whether these spectral coefficients are indicative of playback through a loudspeaker. Additionally or alternatively, properties about a channel and/or noise may be obtained for the voiced speech and the unvoiced speech, and the determination may be based on whether the properties of the channel and/or noise are indicative of playback through a loudspeaker.

In some embodiments, in response to the determination that the received speech signal does contain live speech by the liveness detection block 112, a voice biometrics process may be executed by the smartphone 10. Alternatively, in response to the liveness detection block 112 determining that the received speech signal does not contain live speech (as would be the case in a replay attack), the liveness detection block 112 may prevent a further voice biometrics process from being executed. Thus, the method described with reference to FIGS. 5 and 6 may effectively prevent access to a voice biometrics process in a system when it has been determined that a received speech signal does not contain live speech. Additionally, in an always-on voice biometrics system, the method described with reference to FIGS. 5 and 6 may allow power to be saved by the system when it has been determined that a received speech signal does not contain live speech, as there is no need for a further speaker recognition process to be executed following this determination.

As mentioned above, as only two time-frequency transformation operations need to be performed as part of the method described with reference to FIGS. 5 and 6, the computational intensity and execution time of the method are considerably reduced. The computational cost of the method described with reference to FIGS. 5 and 6 is approximately F*N +N*log₂(N), where F is the number of frames, and N is the number of samples per frame.

For example, for a signal sampled at 48 KHz, where N=1024, and where adjacent frames overlap by 50% (and therefore, the signal is sampled at a rate of 94 frames per second), the cost of the prior art method would be approximately 94*1024*10=0.96 MIPS whereas the cost of the method described with reference to FIGS. 5 and 6 would be approximately 94*1024+1024*10=0.11 MIPS.

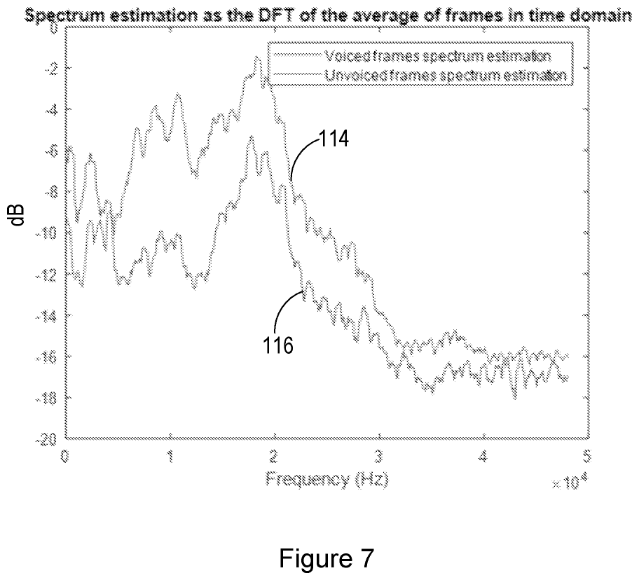

FIG. 7 shows examples of the power density spectra generated by the time-frequency transformation blocks 98,106. The line 114 indicates the average power density spectra for the voiced frames in the received signal, and the line 116 indicates the average power density spectra for the voiced frames in the received signal.

With reference to FIG. 5 above, the voiced/unvoiced detection block 92 may implement any suitable method for determining whether a received signal contains voiced or unvoiced speech in the time domain. This determination in the time domain may prevent a time-frequency transformation operation from needing to be performed on each frame in order to then detect whether each frame contains voiced or unvoiced speech. One example method and system for determining whether a signal contains voiced speech or unvoiced speech are described below.

FIG. 8 is flow chart illustrating a method of determining whether a signal contains voiced speech or unvoiced speech, and FIG. 9 is a block diagram illustrating a system for determining whether a signal contains voiced speech or unvoiced speech.

It will be appreciated that the method of FIG. 8 may be performed by the voiced/unvoiced detection block 92 described above. Similarly, the system of FIG. 9 may be comprised within the voiced/unvoiced detection block 92 described above.

Initially, the received signal may be optionally received at a downsampling block 140 of the system of FIG. 9. The downsampling block 140 may downsample the signal to form a downsampled signal. It will be appreciated that the signal may be downsampled to a sample rate that is commonly used in voice biometrics processes. For example, the signal may be downsampled to a rate between 8 kHz and 24 kHz, typically 16 kHz.

The signal is then passed to a first high pass filtering block 142. The first high pass filtering block 142 performs a first high pass filtering process on the signal to form a filtered signal, as shown in step 120 of FIG. 8. In some embodiments, the first high pass filtering process may have a cutoff frequency between 50-150 Hz, for example 90 Hz. It will be appreciated that this filtering process may eliminate energy contributions from the received signal that are below a frequency of that which can be produced by a human phoneme.

A first copy of the filtered signal is then passed to a second high pass filtering block 144. The second high pass filtering block 144 performs a second high pass filtering process on the filtered signal to form a second filtered signal, as shown in step 122 of FIG. 8. In some embodiments, the second high pass filtering process may comprise a cutoff frequency between 3000-8000 Hz, for example 5000-7000 Hz, typically 6000 Hz.

The second filtered signal is then passed to a first energy calculation block 146. The energy calculation block 146 calculates the energy of the second filtered signal, as shown at step 126 of FIG. 8.

A second copy of the filtered signal is also passed from the first high pass filtering block 142 to a low pass filtering block 148. The low pass filtering block 148 performs a low pass filtering process on the filtered signal to form a third filtered signal, as shown in step 124 of FIG. 8. In some embodiments, the low pass filtering process may comprise a cutoff frequency between 700-3000 Hz, for example 1000 Hz.

It will be appreciated that, in some embodiments, one or more of the first high pass filtering process, the second high pass filtering process and the low pass filtering process may comprise a Chebyshev filtering process. It will appreciated that the skilled person will be aware of additional suitable filtering processes that may be performed as part of the method.

The third filtered signal is then passed to a second energy calculation block 150. The second energy calculation block calculates the energy of the third filtered signal, as shown at step 128 of FIG. 8.

Both the energy of the second filtered signal, and the energy of the third filtered signal, are then passed to a comparison block 152. The comparison block 152 compares the energy of the second filtered signal and the energy of the third filtered signal, as shown at step 130 of FIG. 8.

The result of this comparison is then passed to decision block 154. The decision block then determines, based on the comparison, whether the signal contains voiced speech, or contains unvoiced speech, as shown in step 132 of FIG. 8. In some embodiments, the step of determining whether the signal contains voiced speech, or contains unvoiced speech may comprise determining that the signal contains voiced speech in response to the energy of the second filtered signal exceeding the energy of the third filtered signal, and determining that the signal that contains unvoiced speech in response to the energy of the second filtered signal failing to exceed the energy of the third filtered signal. In other words, it is expected that the signal will contain voiced speech when the energy of the signal exceeds a certain threshold amount, and whether this threshold has been exceeded can be determined based on this aforementioned comparison.

It will be appreciated that, for this method of detecting voiced and unvoiced speech, as it is not necessary to perform a time-frequency transformation operation on each frame, both the computational intensity and execution time of the method are considerably reduced.

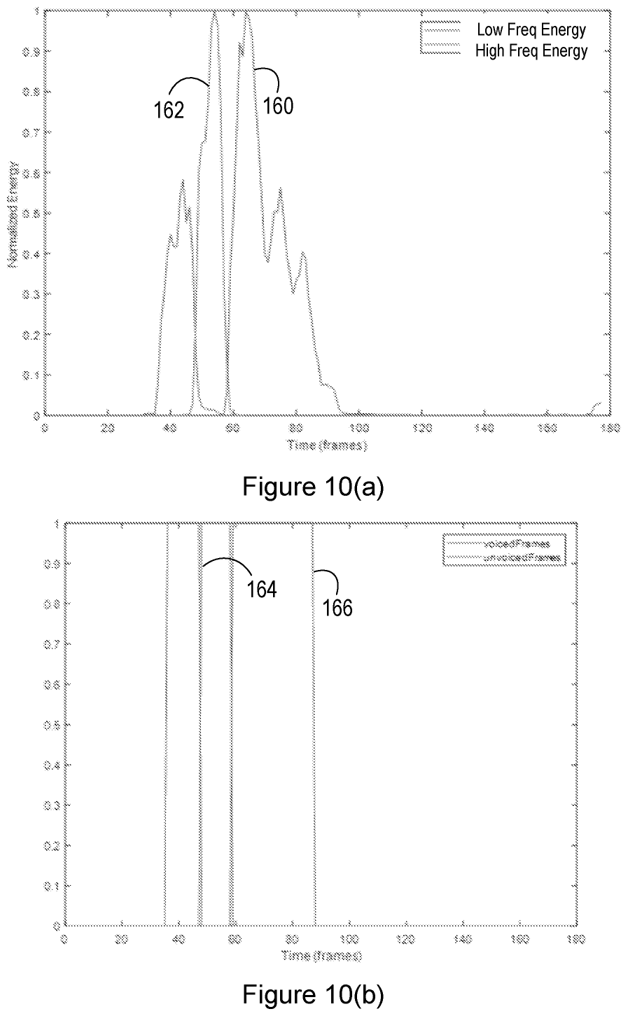

FIG. 10(a) shows examples of the second filtered signal 162 produced by the second high pass filtering block 144, and the third filtered signal 160 produced by the low pass filtering block 148. In this illustrated example, the received signal (on which the second filtered signal and the third filtered signal are based) represents speech containing a three syllable phrase, in which the second syllable contains a sibilant sound. Thus, the amount of energy at the high frequencies is bigger than the amount of energy at low-frequencies during the middle part of the phrase. In this Figure, the energy of both signals has been normalized, such that the maximum energy of either signal is one.

FIG. 10(b) shows which frames have been indicated by the comparison block 152 as voiced frames, or as unvoiced frames. The line 164 indicates which of the numbered frames have been marked as being unvoiced frames (where 0 indicates the frame is voiced, and 1 indicates that the frame is unvoiced). The line 166 indicates which of the numbered frames have been marked as being voiced frames (where 0 indicates the frame is unvoiced, and 1 indicates that the frame is voiced).

Referring now to FIG. 10(a), for frames 1-35, the energy of both the second filtered signal 160 and the third filtered signal 162 is below a threshold. Thus, as shown in FIG. 10(b), none of the frames have been indicated as containing either voiced, or unvoiced, speech.

For frames 36-45, the energy of the third filtered signal exceeds the energy of the second filtered signal (which remains below a threshold). Thus, as shown in FIG. 10(b), as the energy 160 of the third filtered signal exceeds the energy 162 of the second filtered signal, the frames 36-45 have been indicated as containing voiced speech.

For frames 46-60, the energy of the second filtered signal exceeds the energy of the third filtered signal (which returns to a value that is less than the energy of the second filtered signal). Thus, as shown in FIG. 10(b), as the energy 162 of the second filtered signal exceeds the energy 160 of the second filtered signal, the frames 46-60 have been marked as containing unvoiced speech. In this illustrated example, these frames correspond to the sibilant sound in the three syllable phrase mentioned above.

For frames 61-87, the energy of the third filtered signal exceeds the energy of the second filtered signal (which remains at zero). Thus, as shown in FIG. 10(b), as the energy 160 of the third filtered signal exceeds the energy 162 of the second filtered signal, the frames 61-87 have been marked as containing voiced speech.

For frames 88-180, the energy of both the second filtered signal 162 and the third filtered signal 160 is zero. Thus, as shown in FIG. 10(b), none of these frames have been marked as containing either voiced, or unvoiced, speech.

A further method of detecting live speech is now described.

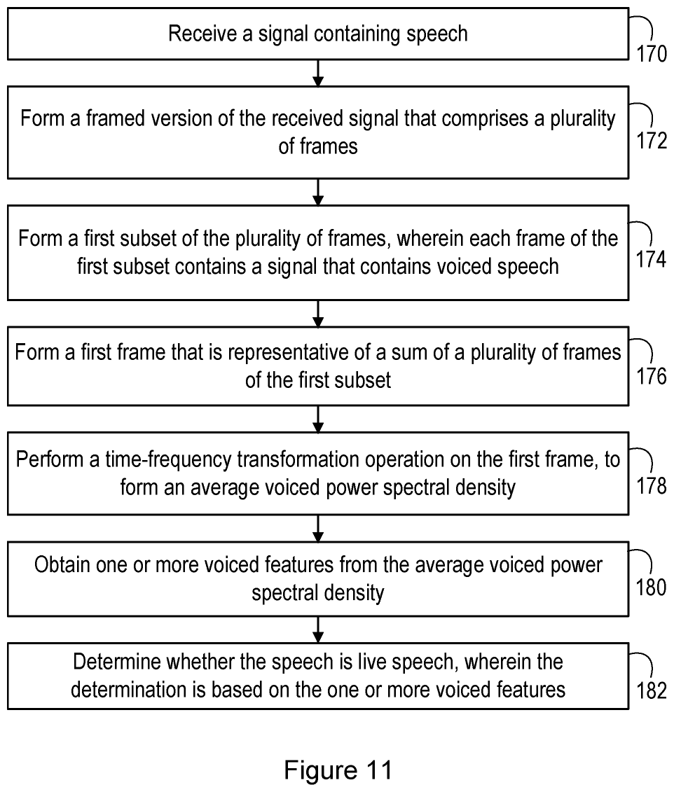

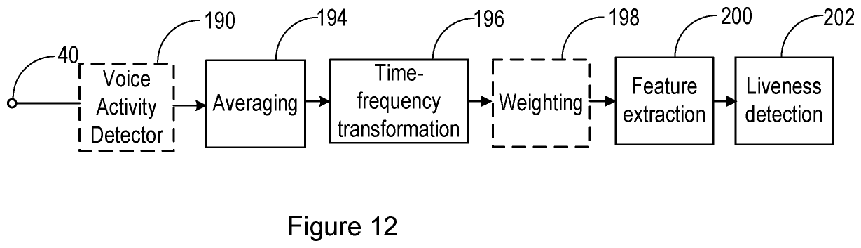

FIG. 11 is a flow chart illustrating a further method of detecting live speech, and FIG. 12 is a block diagram illustrating a further system for detecting live speech.

Specifically, in step 170 of the method FIG. 11, a signal containing speech is received on an input 40 of the system shown in FIG. 12. As mentioned above, the input 40 may comprise the microphone 12 as described above.

The received signal then is divided into frames, which may for example have lengths in the range of 10-100 ms. In some embodiments, the frames may feature a degree of overlap with one another. Thus, as shown in step 172 of FIG. 5, a framed version of the received signal that comprises a plurality of frames is formed. The framed version of the received signal is then passed to a voice activity detector 190. It will be appreciated that, in some embodiments, the framed version of the received signal may be formed such that the overlap between the frames is not constant. For example, two successive overlaps may vary by a predetermined number of samples (for example, between 1-3 samples).

5

The voice activity detector 190 then, for each of the plurality of frames, performs a voice activity detection process on the signal contained in the frame. In response to voice activity being detected in the signal contained in the frame, the voice activity detector 190 determines that the frame contains a signal that contains voiced speech. In some embodiments, the voice activity detector 190 may determine that a frame contains voiced speech if the energy within the frame exceeds a certain threshold. The voice activity detector 190 then forms a first subset of the plurality of frames, wherein each frame of the first subset contains a signal that contains voiced speech, as shown in step 174 of FIG. 11.

It will be appreciated that the voice activity detection block 190 may be substituted with either the voiced/unvoiced detection blocks 92, or the system of FIG. 9, described above. However, it will be also appreciated that, where it is only necessary that voiced frames be identified, providing a voice activity detection block may offer further computational savings to the method.

The plurality of frames of the first subset may then be passed to an averaging block 194. The averaging block 194 forms a first frame that is representative of a sum of a plurality of frames of the first subset, as shown in step 176 of FIG. 5. For example, the first frame may comprise an average frame that is based on a sum of the plurality of frames of the first subset. In some embodiments, the process of forming a sum of the plurality of frames may be an analog computing process.

The first frame is then passed to a time-frequency transformation block 196. The time-frequency transformation block 196 performs a time-frequency transformation operation on the first frame to form an average voiced power spectral density, as shown in step 178 of FIG. 11. In some embodiments, the time-frequency transformation operation may comprise at least in part a discrete Fourier transform. However, it will be appreciated that the time-frequency transformation operation may comprise any suitable transformation or transformations that allow a power spectral density to be formed.

The average voiced power spectral density may then optionally be passed to a weighting block 198. The weighting block 198 may apply a weight to the average voiced power spectral density to form a weighted average voiced power spectral density. In some embodiments, the weight may be based on the energy of the first frame. It will be appreciated that the weighting process may compensate for energy that may have been lost when the average voiced power spectral density was initially formed.

The average voiced power spectral density may then be passed to a feature extraction block 200. The feature extraction block 200 obtains one or more voiced features from the average voiced power spectral density, as shown in step 180 of FIG. 11. It will be appreciated that, where a weighted average voiced power spectral density has been received from the weighting block 198, the one or more voiced features may be obtained from the weighted average voiced power spectral density. It will be appreciated that the feature extraction block 200 may obtain any voiced features from the average voiced power spectral density that are suitable for use in a liveness detection process. For example, a ratio of the signal energy from 20-40 kHz (ultrasonic) to the signal energy from 100 Hz-15 kHz (audible) may be obtained. Additionally or alternatively, a ratio of the energy within a certain frequency band to the energy of the complete power spectral density may be obtained. Additionally or alternatively, spectral coefficients may be obtained. Additionally or alternatively, properties about a channel and/or noise may be obtained.

A liveness detection block 202 receives the one or more voiced features from the feature extraction block 200. The liveness detection block 202 determines whether the speech is live speech based on the one or more voiced features, as shown in step 182 of FIG. 11. In some embodiments, this determination may be based on received frequency properties of the voiced speech. Additionally or alternatively, the liveness detection block 202 may test whether a particular spectral ratio (for example a ratio of the signal energy from 20-40 kHz (ultrasonic) to the signal energy from 100 Hz-15 kHz (audible)) has a value that may be indicative of replay through a loudspeaker, for the voiced speech. Additionally or alternatively, the liveness detection block 202 may test whether the ratio of the energy within a certain frequency band to the energy of the complete power spectral density has a value that may be indicative of replay through a loudspeaker, for the voiced speech. Additionally or alternatively, the determination may be based on spectral coefficients that have been calculated for the voiced power density spectrum, and whether these spectral coefficients are indicative of playback through a loudspeaker. Additionally or alternatively, properties about a channel and/or noise may be obtained for the voiced speech, and the determination may be based on whether the properties of the channel and/or noise are indicative of playback through a loudspeaker.

In some embodiments, in response to the determination that the received speech signal does contain live speech by the liveness detection block 202, a voice biometrics process may be executed by the smartphone 10. Alternatively, in response to the liveness detection block 202 determining that the received speech signal does not contain live speech (as would be the case in a replay attack), the liveness detection block 202 may prevent a further voice biometrics process from being executed. Thus, the method described with reference to FIGS. 11 and 12 may effectively prevent access to a voice biometrics process in a system when it has been determined that a received speech signal does not contain live speech. Additionally, in an always-on voice biometrics system, the method described with reference to FIGS. 11 and 12 may allow power to be saved by the system when it has been determined that a received speech signal does not contain live speech, as there is no need for a further speaker recognition process to be executed following this determination.

Furthermore, as only one time-frequency transformation operation need to be performed, and only frames containing voiced speech need to be identified as part of the method described with reference to FIGS. 11 and 12, the computational intensity and execution time of the method are considerably reduced.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA.

The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A method of detecting live speech, the method comprising:
receiving a signal containing speech;
forming a framed version of the received signal that comprises a plurality of frames;
forming a first subset of the plurality of frames, wherein each frame of the first subset contains a signal that contains voiced speech;
forming a second subset of the plurality of frames, wherein each frame of the second subset contains a signal that contains unvoiced speech;
forming a first frame that is representative of a sum of a plurality of frames of the first subset;
forming a second frame that is representative of a sum of a plurality of frames of the second subset;
performing a time-frequency transformation operation on the first frame, to form an average voiced frequency spectrum;
performing a time-frequency transformation operation on the second frame, to form an average unvoiced frequency spectrum;
obtaining one or more voiced features from the average voiced frequency spectrum;
obtaining one or more unvoiced features from the average unvoiced frequency spectrum; and
determining whether the speech is live speech, wherein the determination is based on the one or more voiced features and the one or more unvoiced features.

2. (canceled)

3. A method according to claim 1, wherein the method further comprises:
applying a weight to the average voiced frequency spectrum to form a weighted average voiced frequency spectrum; and
obtaining said one or more voiced features from the weighted average voiced frequency spectrum.

4. A method according to claim 3, wherein the weight is based on the energy of the first frame or the second frame.

5. A method according to claim 1, wherein the method further comprises:
applying a weight to energy of the average unvoiced frequency spectrum to form a weighted average unvoiced frequency spectrum; and
obtaining said one or more unvoiced features from the weighted average unvoiced frequency spectrum.

6. A method according to claim 5, wherein the weight is based on the energy of the first frame or second frame.

7. A method according to claim 1, wherein the step of forming a framed version of the received signal comprises varying an overlap between two or more frames of the plurality of frames.

8. A method according to of claim 7, wherein the overlap is varied randomly.

9. A method according to claim 1, wherein the steps of forming a first subset of the plurality of frames, and forming a second subset of the plurality of frames, comprises, for each frame of the plurality of frames:
determining whether the signal comprised within the frame contains voiced speech or unvoiced speech.

10.-11. (canceled)

12. A system for detecting live speech, the system comprising an input for receiving an audio signal, and being configured for:
receiving a signal containing speech;
forming a framed version of the received signal that comprises a plurality of frames;
forming a first subset of the plurality of frames, wherein each frame of the first subset contains a signal that contains voiced speech;
forming a second subset of the plurality of frames, wherein each frame of the second subset contains a signal that contains unvoiced speech;
forming a first frame that is representative of a sum of a plurality of frames of the first subset;
forming a second frame that is representative of a sum of a plurality of frames of the second subset;
performing a time-frequency transformation operation on the first frame, to form an average voiced frequency spectrum;
performing a time-frequency transformation operation on the second frame, to form an average unvoiced frequency spectrum;
obtaining one or more voiced features from the average voiced frequency spectrum;
obtaining one or more unvoiced features from the average unvoiced frequency spectrum; and
determining whether the speech is live speech, wherein the determination is based on the one or more voiced features and the one or more unvoiced features.

13. A non-transitory computer readable storage medium having computer-executable instructions stored thereon that, when executed by processor circuitry, cause the processor circuitry to perform a method according to claim 1.

14. A method of determining whether a signal contains voiced speech or unvoiced speech, the method comprising:
performing a first high pass filtering process on the signal to form a filtered signal;
performing a second high pass filtering process on the filtered signal to form a second filtered signal;
performing a low pass filtering process on the filtered signal to form a third filtered signal;
calculating the energy of the second filtered signal;
calculating the energy of the third filtered signal;
comparing the energy of the second filtered signal and the energy of the third filtered signal; and
based on said comparison, determining whether the signal contains voiced speech, or contains unvoiced speech.

15.-18. (cancelled)

19. A method according to claim 14, wherein the step of determining whether the signal contains voiced speech, or contains unvoiced speech comprises:
responsive to the energy of the second filtered signal exceeding the energy of the third filtered signal, determining that the signal contains voiced speech; and
responsive to the energy of the second filtered signal failing to exceed the energy of the third filtered signal, determining that the signal that contains unvoiced speech.

20. (canceled)

21. A system for determining whether a signal contains voiced speech or unvoiced speech, the system comprising an input for receiving an audio signal, and being configured for:
performing a first high pass filtering process on the signal to form a filtered signal;
performing a second high pass filtering process on the filtered signal to form a second filtered signal;
performing a low pass filtering process on the filtered signal to form a third filtered signal;
calculating the energy of the second filtered signal;
calculating the energy of the third filtered signal;
comparing the energy of the second filtered signal and the energy of the third filtered signal; and
based on said comparison, determining whether the signal contains voiced speech, or contains unvoiced speech.

22. A non-transitory computer readable storage medium having computer-executable instructions stored thereon that, when executed by processor circuitry, cause the processor circuitry to perform a method according to claim 14.

23. A method of detecting live speech, the method comprising:
receiving a signal containing speech;
forming a framed version of the received signal that comprises a plurality of frames;
forming a first subset of the plurality of frames, wherein each frame of the first subset contains a signal that contains voiced speech;
forming a first frame that is representative of a sum of a plurality of frames of the first subset;
performing a time-frequency transformation operation on the first frame, to form an average voiced frequency spectrum.
obtaining one or more voiced features from the average voiced frequency spectrum;
determining whether the speech is live speech, wherein the determination is based on the one or more voiced features.

24.-25. (canceled)

26. A method according to claim 23, wherein the method further comprises:
applying a weight to the average voiced frequency spectrum to form a weighted average voiced frequency spectrum; and
obtaining said one or more voiced features from the weighted average voiced frequency spectrum.

27. A method according to claim 26, wherein the weight is based on the energy of the first frame.

28. A method according to claim 23, wherein the step of forming a framed version of the received signal comprises varying an overlap between two or more frames of the plurality of frames.

29. A method according to claim 28, wherein the overlap is varied randomly.

30.-31. (canceled)

32. A system for detecting live speech, the system comprising an input for receiving an audio signal, and being configured for:
receiving a signal containing speech;
forming a framed version of the received signal that comprises a plurality of frames;
forming a first subset of the plurality of frames, wherein each frame of the first subset contains a signal that contains voiced speech;
forming a first frame that is representative of a sum of a plurality of frames of the first subset;
performing a time-frequency transformation operation on the first frame, to form an average voiced frequency spectrum. obtaining one or more voiced features from the average voiced frequency spectrum;
determining whether the speech is live speech, wherein the determination is based on the one or more voiced features.

33. A non-transitory computer readable storage medium having computer-executable instructions stored thereon that, when executed by processor circuitry, cause the processor circuitry to perform a method according to claim 23.
